(19) United States
(12) Patent Application Publication
(10) Pub. No.: US 2013/0097462 A1
(43) Pub. Date: Apr. 18, 2013

(54) EMBEDDED LOGIC ANALYZER

(71) Applicants: Vivek Singh, Noida (IN); Neeraj Chandak, Noida (IN); Mark Maiolani, East kilbride (GB); Gary L. Miller, Austin, TX (US)

(72) Inventors: Vivek Singh, Noida (IN); Neeraj Chandak, Noida (IN); Mark Maiolani, East kilbride (GB); Gary L. Miller, Austin, TX (US)

(21) Appl. No.: 13/709,049

(22) Filed: Dec. 9, 2012

Related U.S. Application Data
(63) Continuation-in-part of application No. 13/170,286, filed on Jun. 28, 2011.
Application No. 13/170,286 is a continuation-in-part of application No. 13/170,289, filed on Jun. 28, 2011.

(51) Int. Cl. G06F 11/25

(52) U.S. Cl. CPC G06F 11/25
USPC 714/39

(57) ABSTRACT

A logic analyzer embedded in a data processor includes a state processing unit for providing state machines for storing state conditions of functional blocks of the data processor and triggering sequences of states with corresponding actions based on True/False evaluation of state conditions. The configurations of the state machines that can be selected by the user include different combinations of a first clock frequency CLK1, which is the fastest distributed clock frequency of the device, and a second sub-multiple clock frequency CLK1/X for processing different sequences of states and synchronizing state conditions of the state machines. The state processing unit performs sample operations capturing assertion events synchronized by the first clock frequency CLK1, and hold operations on captured assertion events during periods defined by the first or second clock frequency CLK1 or CLK1/X as selected by the user.

### CROSS-REFERENCE TO RELATED APPLICATIONS

This application is related to U.S. patent application Ser. No. 13/170,286, filed on Jun. 28, 2011 entitled “DATA PROCESSING SYSTEM HAVING A SEQUENCE PROCESSING UNIT AND METHOD OF OPERATION,” and U.S. patent application Ser. No. 13/170,289, also filed on Jun. 28, 2011 and entitled “DATA PROCESSING SYSTEM HAVING A SEQUENCE PROCESSING UNIT AND METHOD OF OPERATION,” both of which are assigned to the assignee of the present application.

### BACKGROUND OF THE INVENTION

The present invention is directed to a data processor and, more particularly, to a data processor having an embedded logic analyzer with a sequence processing unit (SPU) that is used to debug and analyze the operation of the data processor.

Logic analyzers may be used for performance monitoring, hardware in-the-loop simulation, calibration, and performance measurement in addition to software debugging. Complex trigger and system performance monitor functions may be implemented in the SPU. System level performance monitor functions can be integrated into the SPU complex trigger logic, and sets of timers and counters can allow counting and timing of various debug trigger combinations supported by the SPU. Various clients may generate watchpoints and triggers when operating in their debug mode. The SPU can collect these triggers (such as interrupt occurrence, address watchpoint, etc.) and use them as conditions to sequence through states, with resultant actions (such as start/stop trace, start/stop counter, and capture time base).

Logic analyzers may save program trace events such as branch history messages and synchronization messages, data trace events, and ownership trace events such as task/process identification messages. An industry standard IEEE_ISTO_{—}5001_{—}2003 relating to an interface through which an embedded logic analyzer communicates its results externally has been developed by the Nexus 5001 Forum, chartered by the Institute of Electrical and Electronics Engineers Industry Standards and Technology Organization (IEEE-ISTO).

External logic analyzers and emulators may be used to debug hardware and software and measure performance; however, their capabilities are limited, especially with today's highly integrated Systems on a Chip (SoC). For example, external logic analyzers must rely on the existence of signal pin-outs or must use delayed serialized transmission, while emulators only mimic characteristics of a SoC.

An external logic analyzer can use a clock signal that is faster than the fastest clock signal available within the data processor, which simplifies sampling and hold operations and debug state machine functions. On the other hand, an embedded logic analyzer using the highest speed processor clock signal available on the chip is restricted from use in some programming cases since not all logic operations can be accomplished in a single clock period. An embedded logic analyzer using a lower speed processor clock signal provides lower resolution but can provide support for multiple active sequences simultaneously, which may be running at different speeds, or support use case requirements to process logical operations (for example increment counter action should be completed for next state) without wasting valuable state resources. It is desirable to reduce or eliminate these disadvantages of an embedded logic analyzer.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of a data processor including a sequence processing unit;

FIG. 2 is a schematic block diagram of the sequence processing unit of the processor of FIG. 1;

FIG. 3 is a schematic block diagram of an embedded logic analyzer in a data processor in accordance with an embodiment of the present invention, given by way of example;

FIG. 4 is a schematic block diagram of elements of a state logic unit module of the embedded logic analyzer of FIG. 3;

FIG. 5 is a schematic block diagram of a scan state condition module and a time-division multiplexer of the state logic unit module of FIG. 4;

FIG. 6 is a detailed schematic block diagram of an example of a sample and hold module of the embedded logic analyzer of FIG. 3;

FIG. 7 is a wave form diagram appearing in one example of operation of the logic analyzer of FIG. 3;

FIG. 8 is a wave form diagram of waveforms appearing in another example of operation of the logic analyzer of FIG. 3;

FIG. 9 is a flow chart of operation of a first configuration of a state machine of the embedded logic analyzer of FIG. 3; and

FIG. 10 is a flow chart of operation of a second configuration of the state machine of the embedded logic analyzer of FIG. 3.

### DETAILED DESCRIPTION OF THE INVENTION

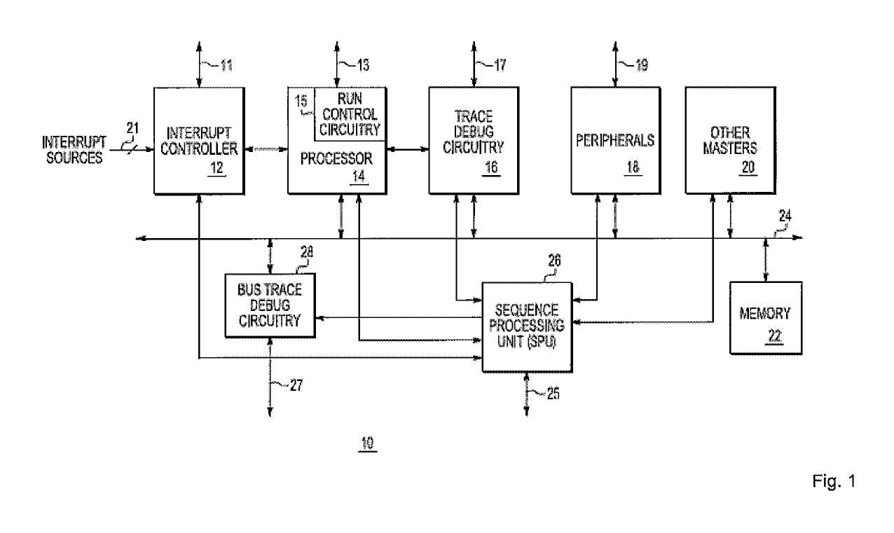

FIG. 1 shows a data processor within a data processing system 10 including a logic analyzer comprising a sequence processing unit (SPU) 26 as described in the afore-mentioned related U.S. patent application Ser. Nos. 13/170,286 and 13/170,289, assigned to the assignee of the present patent application, the disclosures of which are incorporated by reference.

The SPU 26 is capable of validating internal signals of the data processing system 10 and in response thereto can control the data processing system 10 to perform debug operations and/or performance monitoring. The SPU 26 is located on-chip such that it is capable of accessing a variety of internal data processing signals. For example, the SPU 26 may be coupled to receive information from an on-chip interrupt controller, which is not externally accessible, to allow for operations to be performed in response to the information received from the interrupt controller. Also, by being located on-chip, the SPU 26 can interface with other on-chip resources. For example, the SPU 26 can configure and control on-chip trace debug circuitry.

FIG. 1 illustrates an example of the data processing system 10 including an interrupt controller 12, a processor 14, trace debug circuitry 16, peripherals 18, other masters 20, a memory 22, a system interconnect 24, the SPU 26, and bus trace debug circuitry 28. The processor 14 includes run control circuitry 15, and is bi-directionally coupled to the interrupt controller 12 and system interconnect 24. The run control circuitry 15 includes an external port 13. The interrupt controller 12 receives a plurality of interrupt source signals 21 from various parts of the system 10. For example, the interrupt source signals 21 may be received from any of the peripherals 18. The interrupt controller 12 also includes an external port 11. The trace debug circuitry 16 is bi-directionally coupled to the processor 14 and system interconnect 24, and includes an external port 17. The peripherals 18 are bi-directionally coupled to the system interconnect 24 and one or more external ports 19. The peripherals 18 may include any type and number of peripherals, such as, for example, input/output (I/O) devices, timers, memories, etc. The bus trace debug circuitry 28 is bi-directionally coupled to the system interconnect 24 and includes an external port 27. The other masters 20 are bi-directionally coupled to the system interconnect 24 and may include any type and number of masters such as, for example, other processors, co-processors, direct memory access (DMA) devices, etc. Alternatively, no other masters may be present. The memory 22 is bi-directionally coupled to the system interconnect 24 and may be any type of memory, such as, for example, read only memory (ROM), random access memory (RAM), etc. The system interconnect 24 may be implemented as a system bus, or alternatively, as a cross-bar switch or other type of interconnect structure. The SPU 26 is bi-directionally coupled to each of the interrupt controller 12, processor 14, trace debug circuitry 16, bus trace debug circuitry 28, the peripherals 18, and the other masters 20. The SPU 26 also includes an external port 25. The data processing system 10 may be a SoC formed on a single chip or comprise a single integrated circuit. Also, more or fewer than the units illustrated within the system 10 may include an external port for communicating external to the system 10.

In operation, the interrupt controller 12, processor 14, peripherals 18, other masters 20, and memory 22 may operate as known in the art. The SPU 26 receives information from each of the interrupt controller 12, processor 14, peripherals 18, and other masters 20 and, in response thereto, the SPU 26 is able to control various elements of the system 10. For example, the SPU 26 may be capable of interfacing and controlling the trace debug circuitry 16. The SPU 26 is able to generate complex debug events, based upon input triggers from sources throughout system 10. The SPU 26 can create a state machine to trigger various actions, such as debug actions, based on conditions created from the input triggers. Single or multiple actions can be triggered by the state machine, which can result in the creation of various debug events of varying complexity. Also, counters and timers within the SPU 26 are available for counting or timing events. Operation of the SPU 26, interrupt controller 12, run control circuitry 15, and trace debug circuitry 16 will be described in further detail below.

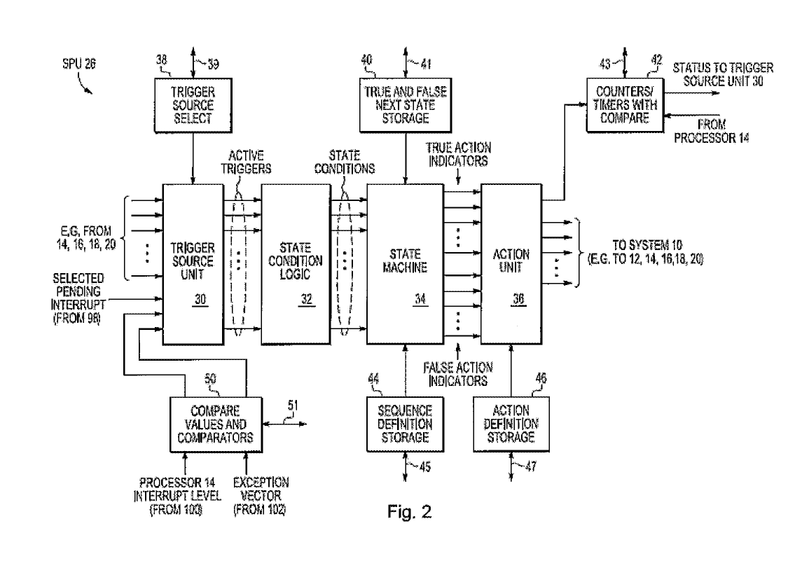

As illustrated in FIG. 2, the SPU 26 includes a trigger source unit 30, state condition logic 32, a state machine 34, action unit 36, trigger source select storage circuitry 38, true and false next state storage circuitry 40, counters/timers with compare circuitry 42, sequence definition storage circuitry 44, action definition storage circuitry 46, and compare values and comparators 50. The trigger source unit 30 receives signals from a variety of different sources and locations within the system 10, such as, for example, from the processor 14, trace debug circuitry 16, peripherals 18, and other masters 20, receives selected pending interrupts from the interrupt controller 12, and is coupled to the compare values and comparators 50, and the trigger select storage circuitry 38. The trigger source unit 30 also provides an integer number of active triggers to the state condition logic 32. The state condition logic 32 provides an integer number of state conditions to the state machine 34. The state machine 34 is coupled to the true and false next state storage circuitry 40 and the sequence definition storage circuitry 44, and provides an integer number of true action indicators and an integer number of false action indicators to the action unit 36. The action unit 36 is coupled to the action definition storage circuitry 46 and the counters/timers with compare circuitry 42, and provides an integer number of action signals to various locations within the system 10, such as, for example, to the interrupt controller 12, processor 14, trace debug circuitry 16, peripherals 18, and other masters 20. The counters/timers with compare circuitry 42 receives an input from the processor 14, and provides status information to the trigger source unit 30. The compare values and comparators circuitry 50 receives an interrupt level of the processor 14 from the interrupt controller 12 and an exception vector from the processor 14.

Each of the trigger source select storage circuitry 38, true and false next state storage circuitry 40, counters/timers with compare circuitry 42, compare values and comparators circuitry 50, sequence destination storage circuitry 44, and action definition storage circuitry 46 includes conductors 39, 41, 43, 51, 45, and 47, respectively, to allow for communications with external ports. For example, the external ports may allow for user configuration, such as, for example, by way of a test port.

In operation, the trigger source unit 30 receives inputs from the system 10 and uses these inputs to generate active triggers to provide to the state condition logic 32. For example, the trigger source unit 30 receives 512 trigger signals from various places within the system 10, which may correspond to various watchpoints set up throughout the system 10. For example, these watchpoints may be generated when certain conditions are met within the system 10. In one example, watchpoints may be generated by the run control circuitry 15 within the processor 14, which monitors operation of the processor 14. For example, the registers of the trace debug circuitry 16 and the compare values and comparators circuitry 50 may be used to indicate when an instruction address of the processor 14 compares favorably to (that is to say matches) a first compare value (where this may correspond to a first watchpoint) or to indicate when an instruction address of the processor 14 compares favorably to a second compare value (where this may correspond to a second watchpoint). These compare values and compares may be performed by the run control circuitry 15, and watchpoints may be generated by other logic in the processor 14 in response to compare events, pipeline events, or in response to other operations. Another watchpoint may correspond to occurrence of a particular debug event within the processor 14, which may also be determined by the run control circuitry 15. Also, the registers of the trace debug circuitry 16 and the compare values and comparators circuitry 50 may be used to indicate when a data address of the processor 14 matches a first data address compare value (which may correspond to yet another watchpoint of system 10), or when a data address of the processor 14 matches a second data address compare value (which may correspond to yet another watchpoint of the system 10). The watchpoints may also be received from other units within system 10, such as the other masters 20, peripherals 18, or system interconnect 24.

The trigger signals received by the trigger source unit 30, in addition to or instead of watchpoint indications, may indicate performance monitor events from the processor 14, peripherals 18, and/or other masters 20, may include status signals from various counters and timers within the system 10, may indicate execution of special instructions (such as, for example, a move to a special purpose register of the processor 14), may indicate writes to special purpose registers, may indicate interrupt execution and/or pending interrupt information, may include peripheral status signals, for example. For example, as illustrated in FIG. 2, selected pending interrupts (received from the interrupt controller 12) are also provided as trigger signals to the trigger source unit 30, as are the outputs of compare values and the comparators circuitry 50. For example, the compare values and comparators circuitry 50 may include storage circuitry for storing a compare value for the interrupt level and a compare value for the exception value, and a trigger signal may be provided based on a comparison between the compare value for the interrupt level and the processor 14 interrupt level and a trigger signal may be provided based on a comparison between the compare value for the exception vector and the currently executing exception vector (from processor 12). In this manner, the SPU 26 can base conditions and actions on the particular interrupt level of the processor 14 or on the exception vector currently being processed by the processor 14. Other compare values and comparators may be used to receive the interrupt level and exception vector of other processors within the system 10 and provide trigger signals accordingly to the trigger source unit 30.

A subset of all received trigger sources may be provided as the active triggers to the state condition logic 32. For example, the trigger source unit 30 may include selection circuitry to select 64 triggers from 512 received triggers to provide to the state condition logic 32 as the active triggers. The selection circuitry includes a set of multiplexers (muxs). In one example, the trigger source unit 30 includes 64 muxs, each having 8 inputs. The trigger source select storage circuitry 38 may store the control information used for selecting the active triggers from the input triggers. The trigger source select storage circuitry 38, for example, provides an appropriate select signal to each of the 64 muxs such that 64 active triggers are generated and provided to the state condition logic 32.

The state condition logic 32 implements a particular number of states that may represent logical combinations of the active triggers received from the trigger source unit 30. For example, in one embodiment, the state condition logic 32 implements 8 states, each of which generates one corresponding state condition. Each state may include combinational logic allowing logical AND/logical OR operations on inputs from the trigger source unit 30 to form state conditions. For example, a state condition can be formed by combinations of logical ANDing and logical ORing of signals, variables, addresses, and data (which can be received by way of the trigger source unit 30). These state conditions are then provided to the state machine 34 to create one or multiple state machines providing different sequences. The state conditions can include operands that are a signal (a scalar value), a variable value (for example a counter or a timer value), an address value, and a data value from a source (for example the processor 14 or the system interconnect 24).

The state machine 34 receives the state conditions and implements configurable state machines to create sequences based on the state conditions. These sequence definitions (that is to say which sequences includes which states) may be stored in the storage circuitry 44. Therefore, the state machine 34 can create complex triggers by joining states together with IF, THEN, and ELSE type operations to create a sequence.

A sequence can implement a state machine in which the state being evaluated may be referred to as the “active state”. Therefore, a sequence a condition is only evaluated for the active state while conditions for the non-active states within the same sequence will be ignored. Each sequence may have the ability to optionally trigger one or more actions based on a true or a false condition from any state in the sequence. Each state in a sequence may have the ability to route to another state on a true condition, and route to another state on a false condition. True and false next state storage circuitry 40 in FIG. 2 may be used to store the next state for each state's true condition and each state's false condition. Typically, each state sets up a condition which if true causes one or more true actions to occur, if any, and the sequence proceeds to a subsequent state (that is to say a “true” next state) and if false causes one or more false actions to occur, if any, and then proceeds to a subsequent state (that is to say a “false” next state). The condition of each state may include, for example, determining if a signal is rising, falling, toggling, asserted, or negated, or if a variable equals or does not equal a particular value, or if a variable is in or out of a particular range, or if an address equals or does not equal a particular address value.

The state machine 34 provides true action indicators and false action indicators to the action unit 36, which then provides the necessary signals to the system 10 for implementing the desired actions. The action unit 36 therefore receives action requests (true action indicators and false action indicators) and may convert the action requests into one or more actions. The actions for each type of action request may be stored, for example, in the action definition storage circuitry 46. That is, the user can define actions associated with each state. These actions may include, for example: starting or stopping trace for a source; starting, stopping, incrementing a counter or timer; resetting a timer or counter; capturing a counter or timer value and placing the specified value into a trace stream; halting a device; generating a watchpoint trigger; capturing a global time base and placing it into a trace stream; generating an interrupt; generating a pulse; starting or stopping a performance counter, such as of the processor 14; starting or stopping traces performed by the trace debug circuitry 16. For example, an action request provided to the action unit 36 may cause the action unit 36 to provide an action of starting or stopping a particular type of trace within the trace debug circuitry 16. That is, the action unit 36 may control the trace debug circuitry 16 so that the trace debug circuitry 16 may start or stop a particular trace. The trace debug circuitry 16 may be capable of providing the following messages indicating the results of performing traces: a data trace message (DTM), an ownership trace message (OTM), a program trace message (PTM), and a watchpoint trace message (WTM). Therefore, the action unit 36 is capable of controlling the trace debug circuitry 16 to start or stop any of these trace streams. Also, the action unit 36 is capable of configuring the trace debug circuitry 16 to configure traces accordingly. In one embodiment, the action unit 36 is capable of searching the action definition storage circuitry 46 (which may be implemented as a memory or as a lookup table) for an entry that indicates an action associated with a particular action request and can generate one or more control signals accordingly.

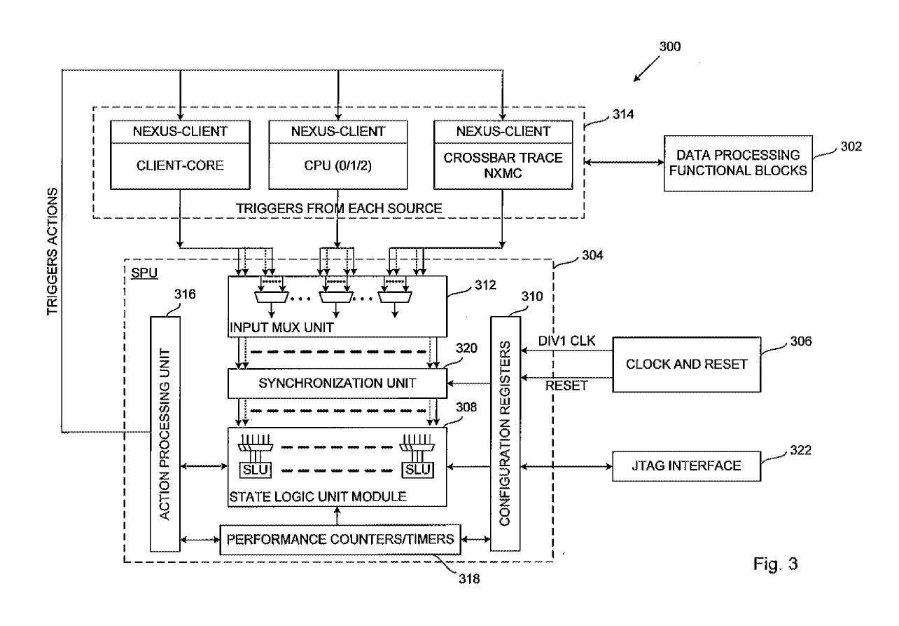

FIG. 3 illustrates a data processor 300 in accordance with an example of an embodiment of the present invention, comprising a plurality of data processing functional blocks 302, an embedded logic analyzer having a sequence processing unit (SPU) 304 and a clock signal generator 306. The data processing functional blocks 302 may be of any suitable type, and may be similar to the functional blocks illustrated in FIGS. 1 and 2, for example. The SPU 304 may perform certain functions, such as state sequences, watchpoints, triggers and other events, corresponding to functions performed by elements such as the SPU 26. The embedded logic analyzer may include elements such as the trace debug circuitry 16 and the bus trace debug circuitry 28 of the system illustrated in FIGS. 1 and 2 in addition to the SPU 304.

The SPU 304 includes a state logic unit module 308 for providing state machines for saving state conditions of the data processing functional blocks 302 and triggering sequences of states with corresponding actions based on True/False evaluation of state conditions, and a configuration register 310 for a user to select among a plurality of configurations of the state machines. The clock signal generator 306 provides a clock signal DIV1 CLK at a first clock frequency CLK1 that is the fastest of distributed clock signals of the data processor 300. The configurations of the state machines that can be selected by the configuration register include different combinations of the first clock frequency CLK1 and a second clock frequency CLK1/X, which is a sub-multiple of the first clock frequency where X is an integer for processing different sequences of states and synchronizing state conditions of the state machines in respective configurations.

The state logic unit module 308 may include a sample and hold logic module 400 for performing a sample operation synchronized by the first clock frequency CLK1 of capturing assertion events, and for performing a hold operation on captured assertion events. The sample and hold logic module 400 may include a detector and sample element 602 for performing the sample operation, and a hold module 604 for holding the captured assertion events. The configuration register 310 may enable the user to select whether the period of the hold operation is defined by the first or the second clock frequency CLK1 or CLK1/X.

In at least one of the configurations of the state machines, the detector and sample element 602 performs the sample operation synchronized by the first clock frequency CLK1, and the hold module 604 holds the captured assertion events during periods defined by the second clock frequency CLK1/X, and the state machines may perform logic operations on assertion events held by the hold module.

In at least one of the configurations of the state machines, the sample and hold logic module 400 performs a sample operation of capturing assertion events on selected signals from data processing functional blocks defined by the configuration register 310, and performs a hold operation on captured assertion events during periods defined by a clock frequency CLK1, which also synchronizes the selected signal. When the state machines then perform logic operations on assertion events held by the hold module 604 during periods defined by the first clock frequency CLK1, which also synchronizes the selected signals, the corresponding actions may be performed with a logic propagation delay of at least one cycle of the first clock frequency CLK1 relative to the sample and hold operation, and when the state machines perform logic operations on assertion events held by the hold module 604 during periods defined by the second clock frequency CLK1/X the corresponding actions are performed in a period of the second clock frequency CLK1/X immediately following the sample and hold operation.

The configuration register 310 may enable the user to select between: the state machines saving state conditions during periods defined by the second clock frequency CLK1/X and triggering simultaneously a plurality of sequences of states with corresponding actions based on True/False evaluation of state conditions, or saving state conditions during periods defined by a clock frequency CLK1, which also synchronizes the selected signals and triggering a single sequence of states with corresponding actions based on True/False evaluation of state conditions.

The state logic unit module 308 may include a time division multiplexer for the user to select the state machines for saving state conditions during periods defined by the second clock frequency CLK1/X and triggering simultaneously a plurality of sequences of states with corresponding actions, or to select a single state machine for saving state conditions during periods defined by a clock frequency CLK1, which also synchronizes the selected signals and triggering a single sequence of states with corresponding actions. The time division multiplexer may assign time slots defined by the first clock frequency CLK1 within the periods defined by the second clock frequency CLK1/X for saving state conditions and triggering respective sequences of states with corresponding actions. The SPU 304 may include an action processing unit for processing the corresponding actions, the action processing unit being common to the state machines and being triggered by the time division multiplexer. The state logic unit module 308 may include a plurality of state logic elements, and the configuration register 310 may assign different active ones of the sequences of states to respective combinations of the state logic elements.

In more detail, the SPU 304 includes an input mux 312, which receives watchpoints, triggers, messages and other events from the data processing functional blocks 302 through an interface 314. The interface 314 can include a Nexus trace interface, for example Nexus 5001. The trace interface 314 can also output to the data processing functional blocks 302 action triggers from an action processing unit 316, corresponding to the action unit 36 of FIG. 2.

The input mux 312 receives watchpoints, triggers, messages and other assertion events from cores, central processing units (CPU) and Nexus multi-master crossbar (NXMC) traces from the data processing functional blocks 302. Selected input signals from the input mux 312, and from performance counters and timers 318, are processed by the state machines of the state logic unit module 308, synchronized by a synchronization unit 320, as selected and controlled by the configuration registers 310. The choices and settings of the user can be set through a pin interface and/or hardware protocol of the Institute of Electrical and Electronics Engineers (IEEE) 1149.1 referred to as a Joint Test Action Group (JTAG) interface 322, for example. The clock signal generator 306 provides the first clock signal DIV1 CLK at the clock frequency CLK1 and a reset signal. The periods defined by the clock frequency CLK1/X are obtained by frequency division, for example by counters.

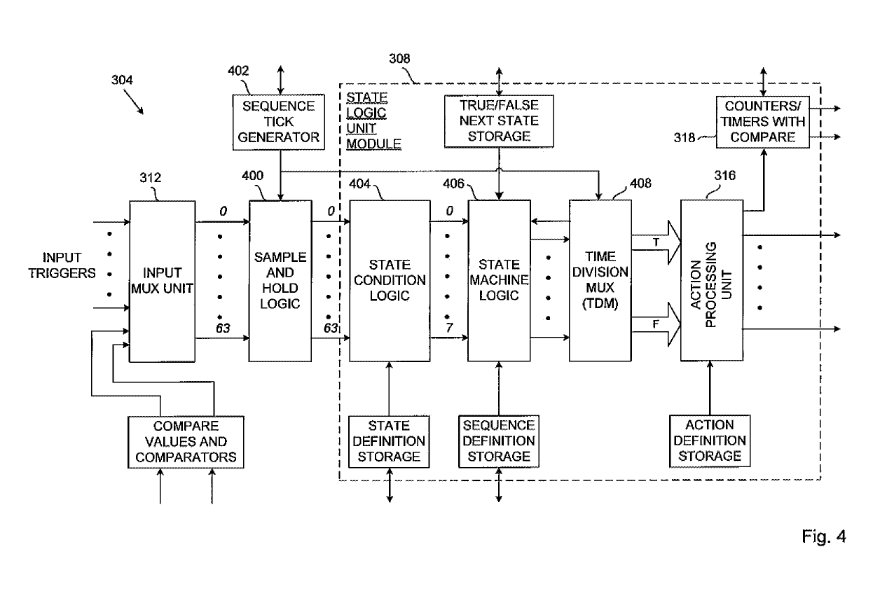

FIG. 4 illustrates an example of elements in the SPU 304. The input mux 312 provides selected trigger events to the sample and hold logic 400, which includes a set of sample and hold sub-units, in this example 63 for handling 64 selected events. The sample and hold logic 400 is synchronized by a sequence tick generator 402 that generates timing signals corresponding to the desired clock frequencies CLK1 and CLK1/X at appropriate time slots, these elements forming part of the synchronization unit 320. The sample and hold logic 400 provides the 64 trigger events to state condition logic 404 in the state logic unit module 308. The state condition logic 404 includes 8 Boolean logic elements that each accept 16 input events and create complex events (True or False conditions for the 8 possible states). The state logic unit module 308 also includes finite state machine logic 406 having 4 separate finite state machine elements that can generate 4 independent active sequences based on the selected states from the state condition logic 404. A single state cannot be used in multiple active sequences.

However, in the SPU 304, the separate finite state machine elements can process 4 independent active sequences based on time-division multiplexing by a TDM module 408 in the state logic unit module 308, which is controlled by the sequence tick generator 402, and which feeds the True/False conditions to the action processing unit 316. Accordingly, the action processing unit 316 can be shared among the 4 active sequences, dividing by 4 the hardware resources needed in the action processing unit 316 to process the 4 independent active sequences.

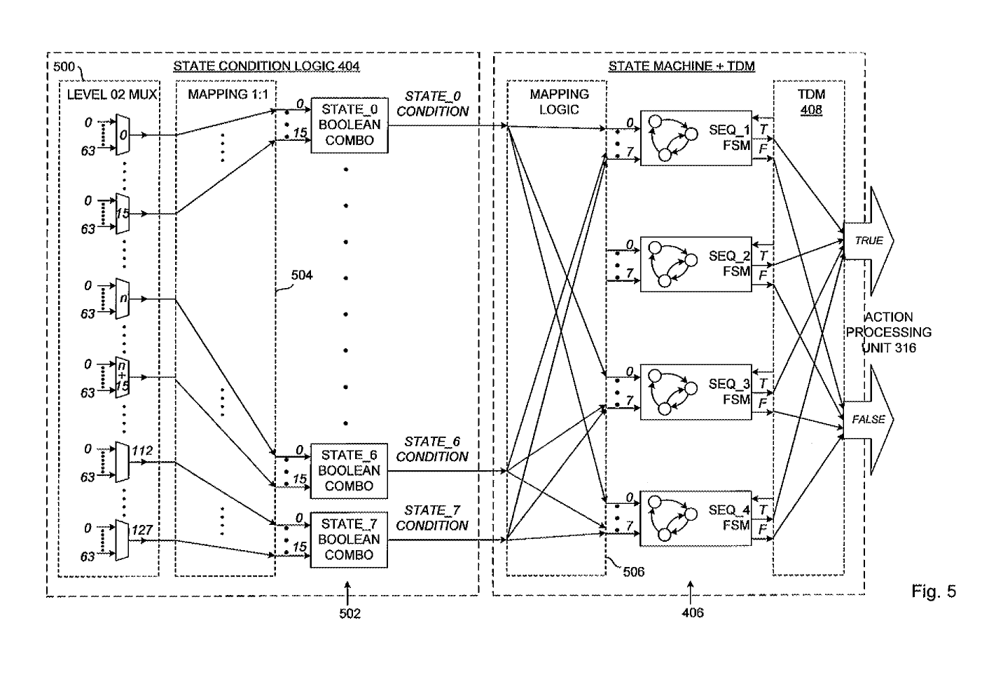

As shown in FIG. 5, in this example of an embodiment of the invention, the state condition logic 404 includes a level 2 mux 500, the level 1 mux being the input mux 312. The inputs to the 8 Boolean logic elements 502 are fed through a mapping unit 504. The outputs of the 8 Boolean logic elements 502 are fed through a mapping unit 506 to the 4 separate finite state machine elements of the state machine logic 406. The outputs of the finite state machine logic 406 are supplied to the action processing unit 316 by the TDM module 408, which limits the sequence processing to a single sequence in any one time slot with the sample and hold logic 400 running at the fastest distributed clock frequency CLK1.

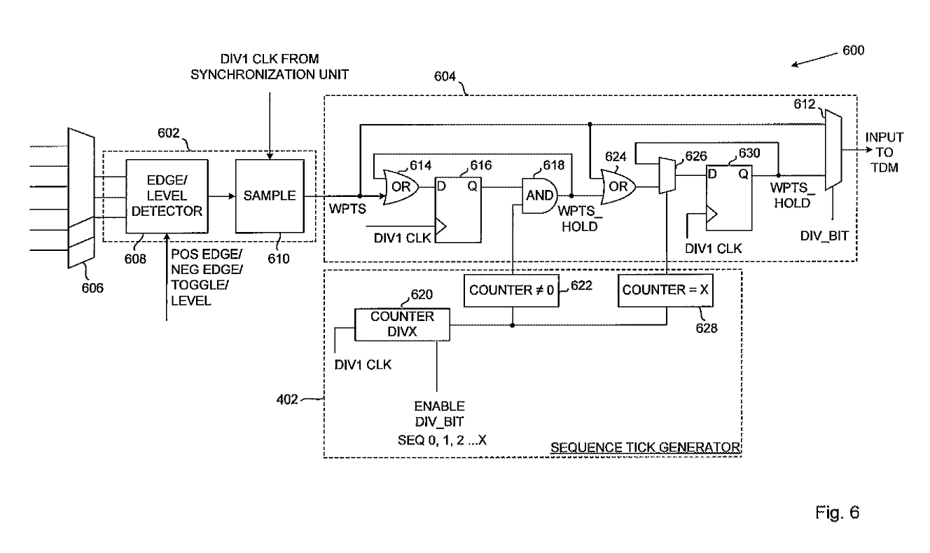

The sample and hold logic module 400 has a set of sample and hold units 600 that receive signals from the input mux 312, there being 64 sample and hold units 600 in this example. FIG. 6 illustrates an example of one of the sample and hold units 600. Input signals from muxes 606 in the input mux 312 are selected and passed to the detector and sample element 602, whose output is passed to the hold module 604. The detector and sample element 602 includes a detector 608 that can be set to detect positive signal edges, negative signal edges, toggle (either a positive edge or a negative edge, indifferently), or signal level relative to a reference, as selected by the user through the configuration registers 310. The detector and sample element 602 also includes a sample circuit 610, which forms corresponding shaped signals timed by the first clock signal DIV1 CLK at the frequency CLK1. In this example, the input signal is shown as a watchpoint trigger WPTS, but it will be appreciated that any suitable input signal can be processed.

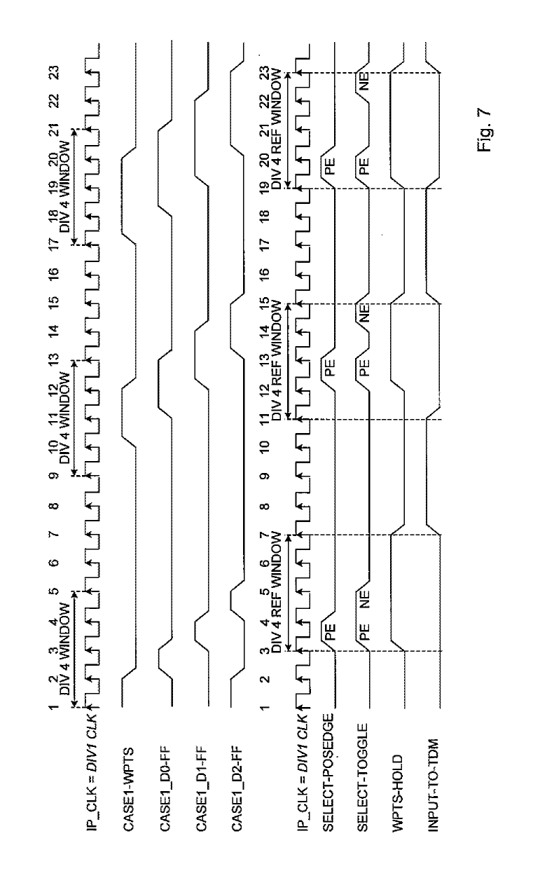

The hold module 604 receives the output signal WPTS of the detector and sample element 602, which it passes to an output mux 612 and to an OR gate 614. The OR gate 614 forms a latch with a flip-flop 616 and an AND gate 618. The flip-flop 616 is clocked by the clock signal DIV1 CLK and its output is connected to one input of the AND gate 618. The sequence tick generator 402 includes a counter 620 that forms a frequency divider defining the periods at the second clock frequency CLK1/X. In this example, the integer X used to divide the clock frequency CLK1 in the frequency divider 616 is equal to four, but it will be appreciated that other division factors can be used. A programmable option signal ENABLE DIV_BIT from the synchronization unit 320 and controlled by the configuration register 310 defines a delay of the window period for the sample and hold unit 600 relative to other sample and hold units in the sample and hold logic module 400. The number of different possible output delays is also equal to X. The output of the counter 620 is passed to the other input of the AND gate 618 through a filter 622, whose output is asserted if the output of the counter 620 is different from 0. Accordingly, as shown in FIG. 7, in operation when the signal WPTS is asserted, the output WPTS-HOLD of the AND gate 618 is immediately asserted and latched until the output of the counter 620 returns to 0 at the end of the window period.

The signal WPTS-HOLD is input to an OR gate 624, which also receives the signal WPTS directly from the detector and sample element 602. The output of the OR gate 624 is input to a mux 626 and is selected by a signal from a filter 628, which is asserted when the output of the counter 620 is equal to X in the last cycle of the clock signal DIV1 CLK of the window period. The output of the mux 626 is input to a flip-flop 630 that is clocked by the clock signal DIV1 CLK. The output of the flip-flop 630 is fed back to the other input of the mux 626 so that in the period following the window period, the output of the latched for the next X cycles of the clock signal DIV1 CLK, as shown at INPUT-TO-TDM in FIG. 7. The output of the flip-flop 630 is also input to the mux 612 and is selected if an input DIV_BIT from the synchronization unit 320 and controlled by the configuration register 310 is asserted. If the input DIV_BIT from the synchronization unit 320 is de-asserted, the signal WPTS directly from the detector and sample element 602 is selected instead. The output of the mux 612 is the output of the sample and hold unit 600 and is input to the state condition logic module 404.

In the configuration where the fastest clock frequency CLK1 distributed in the device is used for the hold operation, the resolution of the logic analyzer is highest but only one sequence of states can be processed by the SPU 304 at a time. In the configuration where the second clock frequency CLK1/X which is a sub-multiple X of the clock signal DIV1 CLK is used, the resolution of the logic analyzer is reduced but up to X sequences of states can be processed by the SPU 304 simultaneously, by time division multiplexing the action logic in the action processing unit 316, at the choice of the user, without multiplying all the state machine hardware resources and action logic by X correspondingly. In the configuration where the second clock signal DIVX CLK is used, samples are taken at the highest clock frequency CLK1, while the sampled assertion events are registered by the hold module 604 in the next period of the lower clock frequency CLK1/X.

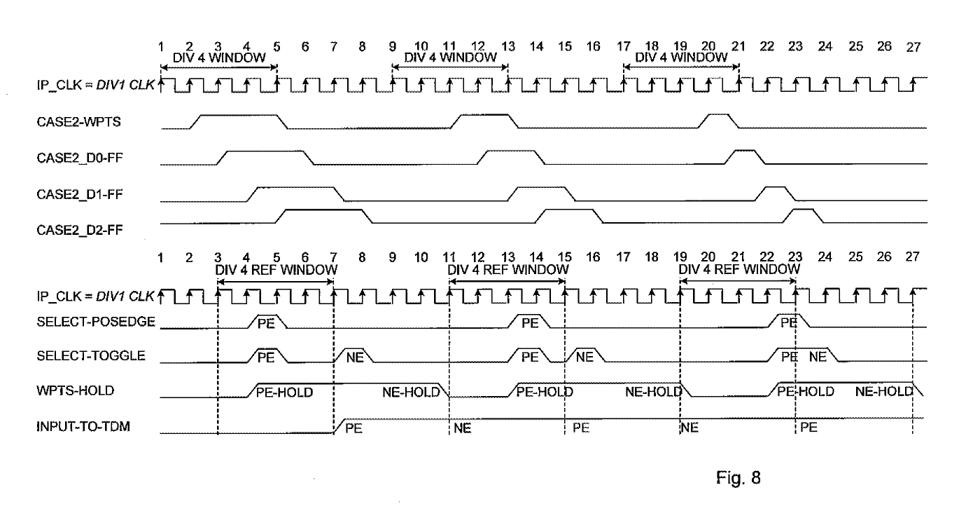

FIGS. 7 and 8 illustrate waveforms appearing in operation of an example of the logic analyzer 300, in the configuration where the second clock frequency CLK1/X is used for the hold operation, where the sub-multiple factor X is equal to 4 and the period of the hold operation is equal to 4 cycles of the first clock frequency CLK1. The waveform IP_CLK is the fastest distributed system clock in the processor device 300 (it may be that phase-locked loop elements for example use faster clocks, but which are not distributed over the processor 300) and is also used as the clock signal DIV1 CLK. The waveform CASE1-WPTS is an example of a watchpoint trigger signal after sampling in the sample circuit 610. The waveforms CASE1-D0-FF to CASE1-D2-FF are shown as if delayed relative to the window period DIV4 REF WINDOW.

DIV4 REF WINDOW is a period timed by the second clock frequency CLK1/X. SELECT-POSEDGE and SELECT-TOGGLE represent the output of the sample circuit 610 for the waveform CASE1-D1-FF respectively if positive edge detection and toggle detection are selected at the detector 608. WPTS-HOLD represents the corresponding signal produced within the hold module 604 within the period DIV4 REF WINDOW, which has a positive edge at the moment of sampling of the positive edge of the waveform CASE1-D1-FF. The hold module 604 holds a positive edge signal for the rest of the corresponding period DIV4 REF WINDOW and therefore masks a negative edge which is sampled in the same period DIV4 REF WINDOW, which is a consequence of the reduced resolution. INPUT-TO-TDM represents the output of the hold module 604, which lasts the whole of the period of the second clock frequency CLK1/X following the period DIV4 REF WINDOW in which the event was sampled.

FIG. 8 also illustrates a consequence of the reduced resolution. In the situation shown in FIG. 7, all the negative edges occur in the same window period as the corresponding positive edges and therefore all of the negative edges are masked. In the situation shown in FIG. 8, the negative edges occur in the following periods from the corresponding positive edges and therefore the output INPUT-TO-TDM of the sample and hold unit 600 remains latched for several periods of the second clock frequency CLK1/X, with the result that both the positive and negative edges are captured.

The elements of FIG. 6 have been illustrated as hardware elements, with gates, flip-flops and physical muxs, by way of example. It will be appreciated that software elements and modules may be used partially or wholly to obtain the desired functions.

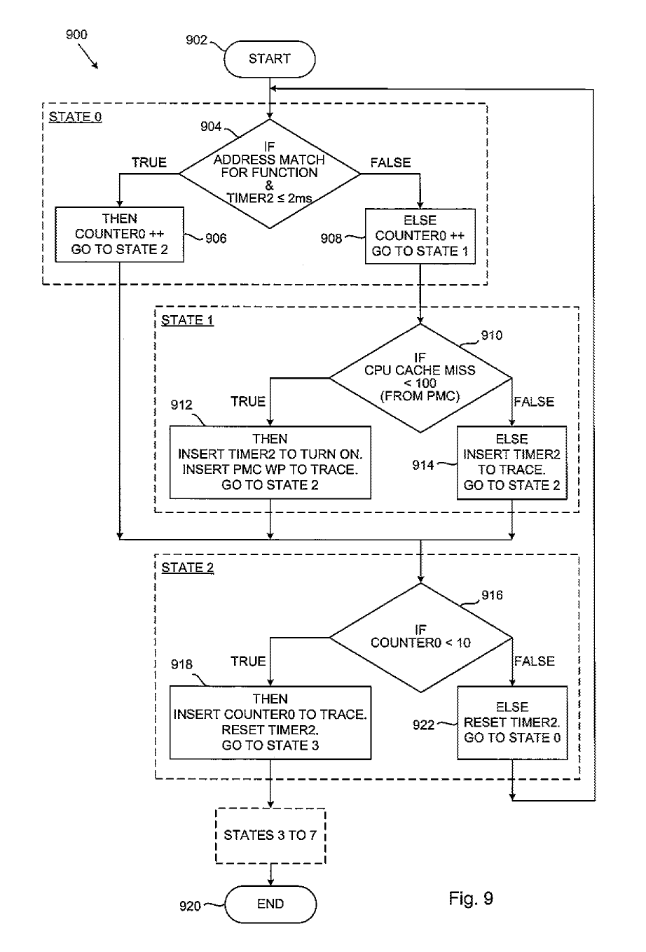

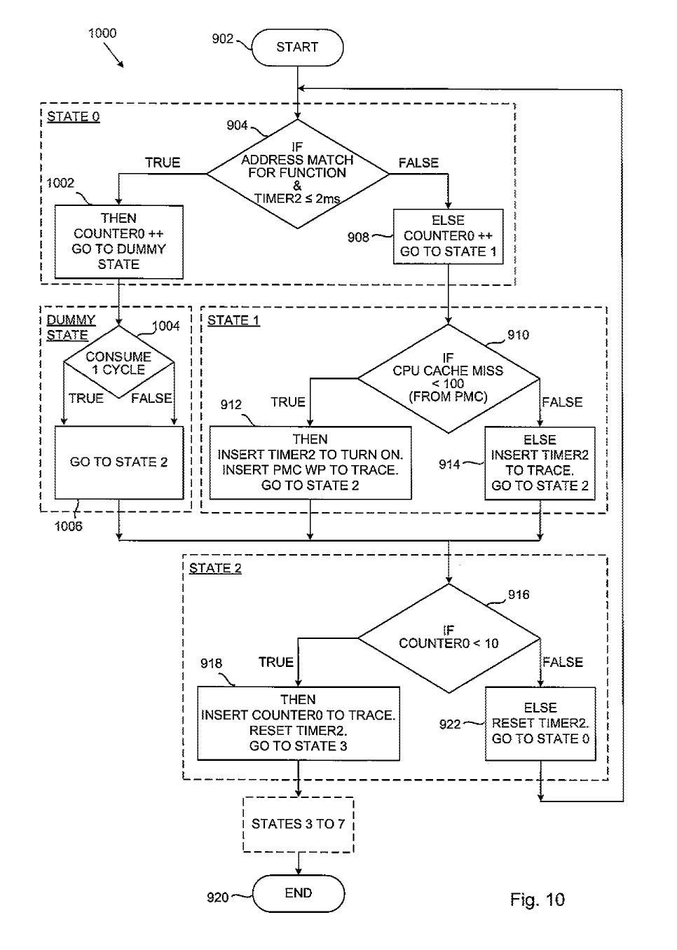

FIGS. 9 and 10 are flow charts illustrating an example of methods of operation 900 and 1000 in configurations of a state machine of the state logic unit module 308 processing watchpoint traces, respectively where the first clock signal DIV1 CLK and the second clock signal DIVX CLK are selected. Referring first to FIG. 9, corresponding to the case where the second clock signal DIVX CLK having a clock frequency that is a sub-multiple X of the first clock signal DIV1 CLK is used, the method 900 starts at 902. In state 0, at 904, a decision is taken whether the address of the input matches the function selected and a timer2 has a time lapse less than or equal to 2 ms. If the result is true, at 906 a counter0 is incremented and the method proceeds to State 2. If the result is false, at 908 the counter0 is incremented and the method proceeds to State 1.

In State 1 at 910, a decision is taken whether a cache miss less than 100 has occurred in a performance monitor counter (PMC). At 912, if the result of 910 is true, an instruction is made to insert the value of the timer2 into the trace, a watchpoint for the PMC is inserted to the trace and the method proceeds to State 2. If the result of 910 is false (cache miss greater than 100), at 914 the value of the timer2 is inserted to the trace and the method proceeds to State 2.

In State 2 at 916, a decision is taken whether the value of counter0 is less than 10. At 918, if the result of 916 is true, the value of the counter0 is inserted to the trace and the method proceeds to further States 3 to 7 (not shown in detail) and the method ends at 920. At 922, if the result of 916 is false (counter0 equal to or greater than 10) timer2 is reset and the method reverts to State 0, step 904.

Referring now to FIG. 10, corresponding to the case where the first clock signal DIV1 CLK is used, the method 1000 is similar to the method 900, except for inserting a delay of one cycle of clock DIV1 CLK before proceeding to state 2 if the result at 904 is true. In state 0, again a decision is taken at 904 whether the address of the input matches the function selected and a timer2 has a time lapse less than or equal to 2 ms and if the result is false, at 908 the counter0 is incremented and the method proceeds to State 1. However, if the result at 904 is true, at 1002 the counter0 is incremented and the method proceeds to a Dummy State. The Dummy State includes a dummy decision 1004, and at 1006, true or false, the method proceeds to decision 916 in State 2 and the method 1000 continues as in method 900.

The procedures or methods of the invention may be implemented at least partially in a non-transitory machine-readable medium containing a computer program for running on a computer system, the program at least including code portions for performing steps of a method according to the invention when run on a programmable apparatus, such as a computer system or enabling a programmable apparatus to perform functions of a device or system according to the invention. A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on non-transitory computer readable media permanently, removably or remotely coupled to an information processing system. The computer readable media may include, for example and without limitation, any number of the following: magnetic storage media including disk and tape storage media; optical storage media such as compact disk media (for example, CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

In the foregoing specification, the invention has been described with reference to specific examples of embodiments of the invention. It will, however, be evident that various modifications and changes may be made therein without departing from the broader spirit and scope of the invention as set forth in the appended claims.

The connections as discussed herein may be any type of connection suitable to transfer signals from or to the respective nodes, units or devices, for example via intermediate devices. Accordingly, unless implied or stated otherwise, the connections may be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

The terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact other architectures can be implemented that achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Those skilled in the art also will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. Further, the examples or portions thereof may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

In the claims, the word ‘comprising’ or ‘having’ does not exclude the presence of other elements or steps then those listed in a claim. Furthermore, the terms “a” or “an,” as used herein, are defined as one or more than one. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe and thus, these terms are not necessarily intended to indicate temporal or other prioritization of such elements. The fact that certain measures are recited in mutually different claims does not indicate that a combination of these measures cannot be used to advantage.

1. A data processor, comprising:
a plurality of data processing functional blocks;
an embedded logic analyzer having a sequence processing unit including a state logic unit module that provides state machines for saving state conditions of said data processing functional blocks and triggering sequences of states with corresponding actions based on True/False evaluation of state conditions, and a configuration register that allows a user to select among a plurality of configurations of said state machines; and
a clock signal generator for providing a clock signal at a first clock frequency that is the fastest clock signal amongst a plurality of distributed clock signals of the data processor,
wherein said configurations of said state machines that can be selected by said configuration register include different combinations of said first clock frequency and a second clock frequency that is a sub-multiple of said first clock frequency for processing different sequences of states and synchronizing state conditions of said state machine in respective configurations.

2. The data processor of claim 1, wherein said state logic unit module includes a sample and hold logic module for performing a sample operation synchronized by said first clock frequency of capturing assertion events, and for performing a hold operation on captured assertion events.

3. The data processor of claim 2, wherein said sample and hold logic module includes a detector and sample element for performing said sample operation, and a hold module for holding said captured assertion events.

4. The data processor of claim 3, wherein said configuration register enables the user to select whether the period of said hold operation is defined by said first or second clock frequency.

5. The data processor of claim 2, wherein in at least one of said configurations of said state machines said sample and hold logic module includes a detector and sample element for performing said sample operation synchronized by said first clock frequency, and a hold module for holding said captured assertion events during periods defined by said second clock frequency, and said state machines perform logic operations on assertion events held by said hold module.

6. The data processor of claim 1, wherein said state logic unit module includes a sample and hold logic module for performing a sample operation of capturing assertion events on selected signals from data processing functional blocks defined by said configuration register and, in at least one of said configurations of said state machines, for performing a hold operation on captured assertion events during periods defined by a clock frequency that also synchronizes said selected signal.

7. The data processor of claim 6, wherein when said state machines perform logic operations on assertion events sampled and held during periods defined by said first clock frequency that also synchronizes said selected signal, said corresponding actions are performed with a logic propagation delay of at least one cycle of said first clock frequency relative to said sample and hold operation and, when said state machines perform logic operations on assertion events held by said sample and hold logic module during periods defined by said second clock frequency, said corresponding actions are performed in a period of said second clock frequency following said sample and hold operation.

8. The data processor of claim 1, wherein said configuration register enables the user to select between:
said state machines saving state conditions during periods defined by said second clock frequency and triggering simultaneously a plurality of sequences of states with corresponding actions based on True/False evaluation of state conditions, and
saving state conditions during periods defined by a clock frequency that also synchronizes the selected signals and triggering a single sequence of states with corresponding actions based on True/False evaluation of state conditions.

9. The data processor of claim 8, wherein said state logic module includes a time division multiplexer that allows the user to select said state machines for saving state conditions during periods defined by said second clock frequency and triggering simultaneously a plurality of sequences of states with corresponding actions, and to select a single state machine for saving state conditions during periods defined by a clock frequency that also synchronizes the selected signals and triggering a single sequence of states with corresponding actions.

10. The data processor of claim 9, wherein said time division multiplexer assigns time slots defined by said first clock frequency within said periods defined by said second clock frequency for saving states and triggering respective sequences of states with corresponding actions.

11. The data processor of claim 9, wherein said sequence processing unit includes an action processing unit for processing said corresponding actions, said action processing unit being common to said state machines and being triggered by said time division multiplexer.

12. The data processor of claim 1, wherein said state logic unit module includes a plurality of state logic elements, and said configuration register assigns different active ones of said sequences of states to respective combinations of state logic elements.
